(19) United States
(12) Patent Application Publication
(10) Pub. No.: US 2010/0175730 A1
(43) Pub. Date: Jul. 15, 2010

(54) MOBILITY ASSISTANCE DEVICE

(76) Inventor: Kevin C. Ruddy, Petersburg, MI (US)

Correspondence Address: FRASER CLEMENS MARTIN & MILLER LLC, 28366 KENSINGTON LANE, PERRYSBURG, OH, 43551, US

(21) Appl. No.: 12/730,341

(22) Filed: Mar. 24, 2010

Related U.S. Application Data
(63) Continuation-in-part of application No. 12/101,269, filed on Apr. 11, 2008.

(51) Int. Cl. A45B 9/04; A61H 3/00

(52) U.S. Cl. 135/77

(57) ABSTRACT

A mobility assistance device is disclosed including a support member having an aperture formed therein. A generally arcuate foot depends from the support member for contacting a support surface such as a floor or the ground. The foot includes a pair of spaced apart ground engaging rocker members and a ground engaging cross-member interposed therebetween. An elongate hollow member is provided having one end coupled to the ground engaging cross-member and extending through the aperture formed in the support member. A shaft having a handle formed at one end thereof is removably received within the elongate hollow member. The shaft and the handle are oriented in respect of the foot to facilitate a proper posture and a gait of a user, thereby maximizing a stability of the user.

### CROSS-REFERENCE TO RELATED APPLICATION

This application is a continuation-in-part of U.S. patent application Ser. No. 12/101,269, filed Apr. 11, 2008, which is incorporated herein by reference in its entirety.

### FIELD OF THE INVENTION

The present invention relates to a mobility assistance device, and more particularly to a mobility assistance device having an arcuate-shaped foot portion and a handle portion attached thereto adapted to maximize a stability of a user.

### BACKGROUND OF THE INVENTION

Mobility or walking assistance devices such as canes and crutches, for example, have frequently been employed to offer stability to those who require mobility assistance. Conventional walking assistance devices comprise a main body portion which is typically a bar or pole formed from wood or metal. The devices are typically cut to a desired length. The devices also include a handle portion disposed at an upper part of the main body, and a foot portion disposed at a lower part of the main body. Typically, the foot portion includes a rubber cap having a flat surface for contacting the ground.

The conventional mobility assistance devices typically have a single foot. A problem encountered by users when using conventional mobility assistance devices is that when the device is extended by the user at angles forwardly or rearwardly, the foot does not provide adequate traction due to minimal surface to surface contact with the ground. Inadequate traction and minimal surface to surface contact between the foot and the ground surface can result in slippage and an undesirable reduction in a stability of the user. Another problem associated with conventional mobility assistance devices is that the single foot provides minimal lateral stability assistance, which leaves the user susceptible to toppling to the sides.

Prior art solutions provide limited resolution to the traction and the lateral stability of the conventional mobility assistance devices that have a single foot. One such solution is disclosed in U.S. Pat. No. 5,301,704. The '704 patent discloses a foot for a walking cane having an narrow elongate arcuate-shaped foot portion. The foot taught by the '704 patent provides increased traction and surface to surface contact when the cane is extended at angles forwardly or rearwardly, and therefore facilitates an increase in the stability of the user. However, the narrow elongate arcuate-shaped foot taught by the '704 patent does not provide stability in a lateral direction.

Another prior art solution is a device including a plurality of feet, typically four, for increasing stability of the user. An example of a mobility assistance device having four feet is disclosed in U.S. Pat. No. 5,806,548. The feet of these devices are typically arranged in a rectangular pattern to provide lateral stability and reduce the susceptibility of the user toppling to the sides. These types of devices, while providing an improvement in lateral stability, provide a minimal surface to surface contact between the ground and the feet thereof when the cane is extended at angles forwardly or rearwardly of the user.

Additionally, the typical mobility assistance devices having a plurality of feet cause a handle thereof to be in a fixed and an awkward position in respect of the user. The position of the handle causes the user to modify his or her posture from a natural, and preferred, position to properly use the cane. The modified posture typically causes the user to modify his or her gait, which can reduce the stability and increase the fatigue of the user of the device. Consequently, the user must either use the device improperly or modify his or her posture, both of which minimize the desired stability benefit of the mobility assistance device.

It would be desirable to produce a mobility assistance device that facilitates a maximization of traction between a foot of the device and a ground, and provides a lateral stability to a user, while facilitating a proper posture of the user.

### SUMMARY OF THE INVENTION

Compatible and attuned with the present invention, a mobility assistance device that facilitates a maximization of a traction between a foot of the device and a ground, and provides a lateral stability to a user, while facilitating a proper posture of the user, has surprisingly been discovered.

In one embodiment, a ground engaging member for a mobility assistance device comprises a support member including an aperture formed therein; a generally arcuate foot depending from the support member for contacting a support surface, the generally arcuate foot including a pair of spaced apart ground engaging rocker members and a ground engaging cross-member interposed between the ground engaging rocker members; and an elongate hollow member having one end coupled to the ground engaging cross-member and extending through the aperture formed in the support member to removably receive an end of a shaft.

In another embodiment, a mobility assistance device comprises a support member including an aperture formed therein; a generally arcuate foot depending from the support member for contacting a support surface, the generally arcuate foot including a pair of spaced apart ground engaging rocker members and a ground engaging cross-member interposed between the ground engaging rocker members; an elongate hollow member having one end coupled to the ground engaging cross-member and extending through the aperture formed in the support member; and a shaft having a first end and a second end, the first end including a handle and the second end removably received within the elongate hollow member, wherein the elongate hollow member is at an angle in respect of vertical to cause the shaft to lean toward one of the ground engaging rocker members.

In another embodiment, a mobility assistance device comprises a support member including an aperture formed therein; a generally arcuate foot depending from the support member for contacting a support surface, the generally arcuate foot including a pair of spaced apart ground engaging rocker members and a ground engaging cross-member interposed between the ground engaging rocker members; and an elongate hollow member having one end coupled to the ground engaging cross-member and extending through the aperture formed in the support member; a shaft having a first end and a second end, the first end including a handle and the second end removably received within the elongate hollow member and abutting the ground engaging cross-member, wherein the elongate hollow member is attached to the ground engaging cross-member member at a position offset toward one of the ground engaging rocker members, and the elongate hollow member is at about a five degree angle in respect of vertical to cause the shaft to lean toward one of the ground engaging rocker members.

### BRIEF DESCRIPTION OF THE DRAWINGS

The above, as well as other advantages of the invention, will become readily apparent to those skilled in the art from reading the following detailed description of a preferred embodiment of the invention when considered in the light of the accompanying drawings in which:

FIG. 1 is a perspective view of a mobility assistance device in accordance with an embodiment of the invention;

FIG. 2 is a side elevational view of the mobility assistance device illustrated in FIG. 1;

FIG. 3 is a front elevational view of the mobility assistance device illustrated in FIG. 1;

FIG. 4 is a top plan view of the mobility assistance device illustrated in FIG. 1;

FIG. 5 is an enlarged bottom plan view of the mobility assistance device illustrated in FIG. 1;

FIG. 6 is an enlarged fragmentary side elevational view of a foot member of the mobility assistance device illustrated in FIG. 1;

FIG. 7 is an enlarged fragmentary side elevational view of the foot member illustrated in FIG. 6 showing a gripping member attached thereto;

FIG. 8a is an enlarged fragmentary side elevational view of the mobility assistance device illustrated in FIG. 1 having a foot member in accordance with another embodiment of the invention; and

FIG. 8b is an enlarged fragmentary side elevational view of the mobility assistance device illustrated in FIG. 1 having a foot member in accordance with another embodiment of the invention;

FIG. 9 is a perspective view of a mobility assistance device in accordance with another embodiment of the invention;

FIG. 10 is a front elevational view of the mobility assistance device illustrated in FIG. 9;

FIG. 11 is an enlarged top plan view of the mobility assistance device illustrated in FIG. 9;

FIG. 12 is an enlarged bottom plan view of the mobility assistance device illustrated in FIG. 9;

FIG. 13 is a enlarged fragmentary front elevational view of the mobility assistance device illustrated in FIG. 9 having a portion cut-away;

FIG. 14 is a enlarged fragmentary exploded perspective view of the mobility assistance device illustrated in FIG. 9; and

FIG. 15 is an enlarged fragmentary bottom plan view of the mobility assistance device illustrated in FIG. 9 showing a gripping member attached thereto.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

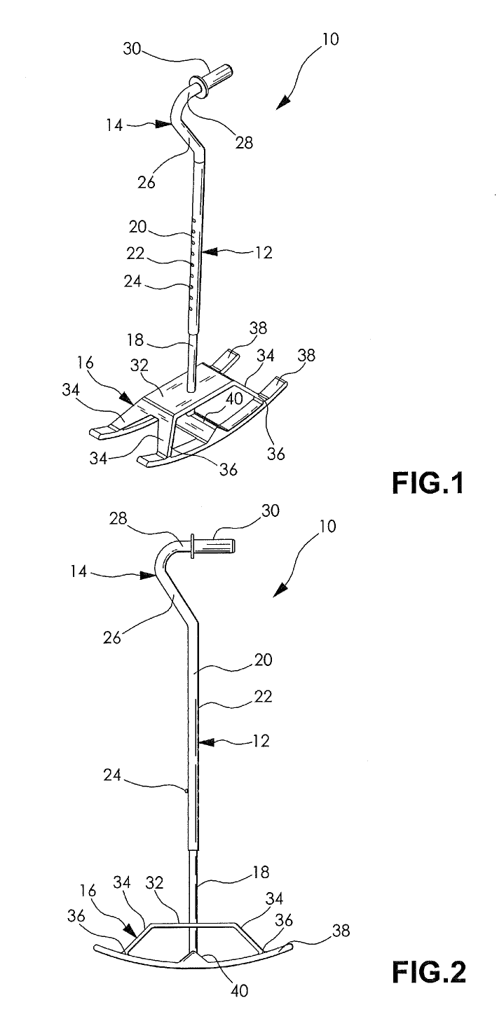

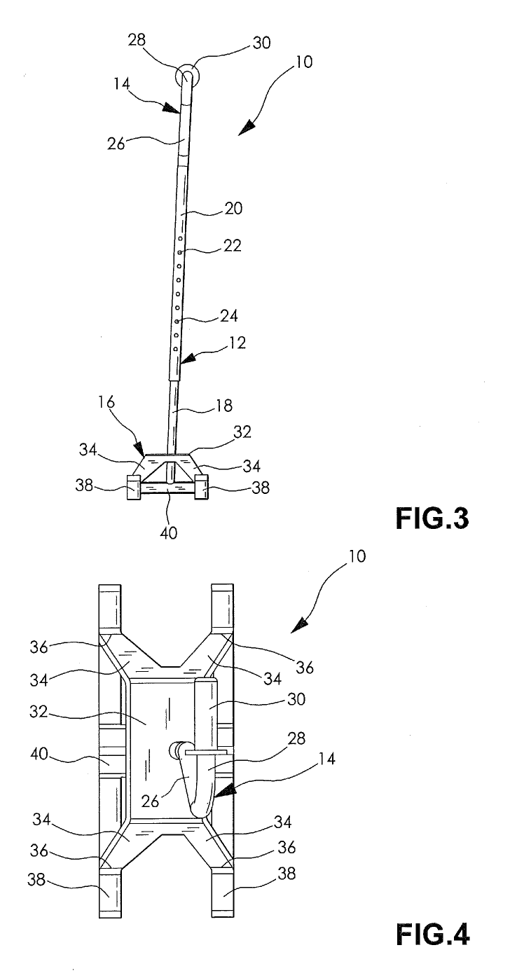

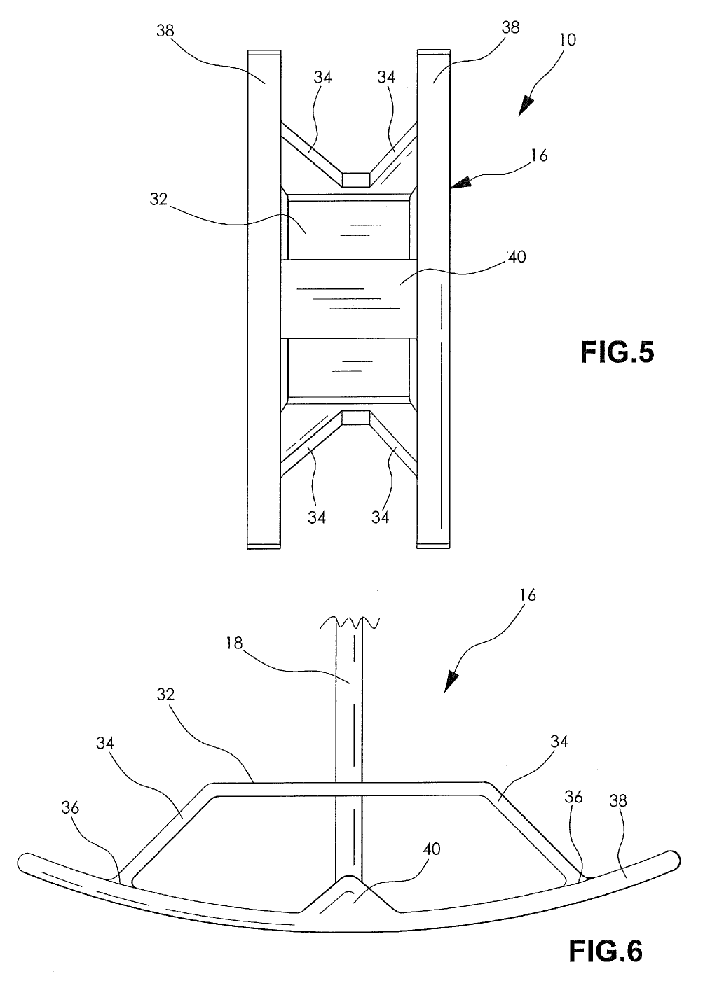

FIGS. 1-7 illustrate a mobility assistance device 10 in accordance with an embodiment of the invention. The mobility assistance device 10 includes a main shaft 12 having a handle 14 disposed at one end and a foot member or a ground engaging member 16 disposed at an opposite end thereof.

The main shaft 12 includes a pair of cooperating elongate members 18, 20 such as tubes for example. One end of member 18 is fixedly attached to the base member 18, and an opposite end thereof is adjustably connected to one end of the elongate member 20. It should be understood that the one end of elongate member 18 can be removably attached to foot member 16. In the embodiment shown, the elongate member 18 is slidably received within the elongate member 20 forming a telescoping connection therebetween to facilitate adjusting the length of the main shaft 12. It should be understood that other means may be employed to adjustably connect the elongate members 18, 20. Additionally, it should be understood that the shaft 12 can be formed from a single elongate member or more than two elongate members as desired. Further, in the illustrated embodiment the main shaft 12 is substantially straight and does not contain bends formed therein. However, it should be understood that the main shaft 12 can have other shapes such as including angled portions or bends therein, for example.

The elongate member 20 includes a plurality of apertures 22 formed therein, aligned in a longitudinal direction thereof. The apertures 22 are adapted to selectively receive a retractable protuberance 24 formed on the elongate member 18 to secure the elongate members 18, 20 in a selected position to provide a desired length to the main shaft 12. A device having this type of protuberance/aperture engagement is disclosed in U.S. Pat. No. 5,301,704, hereby incorporated herein by reference in its entirety. It should be understood that the elongate member 18 can be made to slidably receive elongate member 20 therein, wherein the apertures 22 are formed in the elongate member 20 and the retractable protuberance 24 is formed on the elongate member 18. Additionally, it should be understood that the apertures 22 can be formed in the elongate member 18 and a retractable pin (not shown) can be disposed on the elongate member 20, wherein the retractable pin can be selectively received by the apertures 22 formed in the elongate member 18 to secure the elongate members 18, 20 in a selected position to provide a desired length to the main shaft 12. Other length adjustment structures can be used as desired. Preferably, the elongate members 18, 20 are formed from a lightweight material, such as aluminum, for example. However, other materials can be used to form the elongate members 18, 20 as desired.

The handle 14 is attached to an upper end of the elongate member 18 of the main shaft 12. The handle 14 has a generally inverted L-shape with a leg portion 26 and a grip portion 28. It should be understood that other shapes can be employed for the handle 14 such as a U-shape, for example. In the illustrated embodiment, the handle 14 is integrally formed with the elongate member 18. It should be understood that the handle can be removably and/or adjustably attached to upper end of the elongate member 18. The leg portion 26 is disposed at a forward leaning angle in respect of the main shaft 12 to position the grip portion 28 substantially above the longitudinal axis of the main shaft 12. It should be understood that the leg portion 26 can be disposed in longitudinal alignment with the main shaft 12 or at angles other than the illustrated angle. A grip 30 is disposed on the grip portion 28 to facilitate a user securely grasping the grip portion 28. The grip 30 is formed from a resilient material such as a foam rubber or an elastomeric material, for example. It should be understood that other materials can be employed to form the grip 30. In the embodiment shown, the handle 14 is formed from a lightweight material such as aluminum, for example. However, other materials can be used to form the handle 14 as desired.

The foot member 16 includes a substantially flat plate or support member 32 and a plurality of legs 34 depending therefrom. In the illustrated embodiment, four legs 34 are provided, one adjacent each of a corner of the plate 32. The legs 34 are integrally formed with the plate 32 and extend downwardly therefrom terminating at an end 36. It should be understood that the legs 34 can be formed as a separate component and attached to the plate 32 with a weld or a fastener, for example. Additionally, it should be understood that fewer or additional legs can be provided as desired.

The legs 34 terminate at a pair of spaced apart, arcuate-shaped, ground engaging feet 38. Favorable results have been obtained employing an arcuate-shape having a radius of thirteen inches. However, it should be understood that the arcuate-shape can have a different radius, a plurality of radii, and include linear portions. It should be understood that a single ground engaging arcuate-shaped foot can be provided, or more than two ground engaging, arcuate-shaped, feet can be provided. Favorable results have been obtained employing a pair of feet 38 spaced apart by about four and one half inches, wherein each of the feet 38 is about one inch wide and about ten and one half inches long. It should be understood that the feet 38 can be spaced apart at other distances and have other widths and lengths as desired. Additionally, it should be understood that employing a single foot may require a width thereof substantially equivalent to the distance between the outer edges of the pair of feet 38 to maximize a lateral stability of the mobility device 10. The ends 36 of the legs 34 are fixedly attached to an upper surface of the feet 38. In the illustrated embodiment, the ends 36 of the legs 34 are attached to the feet 38 with a weld. However, it should be understood that the legs 34 can be attached to the feet 38 employing other means such as a fastener, for example. A cross-member 40 is disposed on the upper surfaces of the feet 38 to maximize a structural rigidity of the foot member 16. In the illustrated embodiments, the foot member 16 is formed from aluminum. However, other materials can be used to form the foot member 16 as desired.

The main shaft 12 extends through the plate 32, having the lower end thereof attached to the cross member 40. The main shaft 12 is secured to both the plate 32 and the cross member 40 by a weld thereto, respectively. However, it should be understood that the main shaft 12 can be secured to the plate 32 and the cross member 40 employing other means such as a fastener, for example. The main shaft 12 is attached to the foot member 16 offset from a centerline running between and parallel to a longitudinal axis of the feet 38. The offset positions the main shaft 12 closer to one of the feet 38 or a side of the mobility assistance device 10 towards the user thereof. Additionally, the main shaft 12 is attached to the foot member 14 at an angle, as shown in FIG. 4. Thus, the main shaft 12 is leaning toward the side of the mobility assistance device 10 nearer the user thereof. Additionally, the main shaft 12 is not orthogonal to the support surface, but is disposed at an angle, thereby tilting the main shaft 12 toward the user. Favorable results have been obtained employing a five degree tilt angle for the main shaft 12 from vertical. The offset and angled position of the main shaft 12 cooperate to place the grip portion 28 of the handle 12 in a position facilitating an optimized posture and walking gait of the user. It should be understood that other shaft offsets and tilt angles can be employed as desired to accommodate a particular physical makeup or a physical requirement of the user.

The mobility assistance device 10 illustrated in FIGS. 1-7 is adapted to be employed for supporting a right hand side of the user. However, it should be understood that the elongate member 20 and handle 14 attached thereto can be rotated 180 degrees in respect of the elongate member 18 to facilitate use of the mobility assistance device 10 on a left hand side of the user.

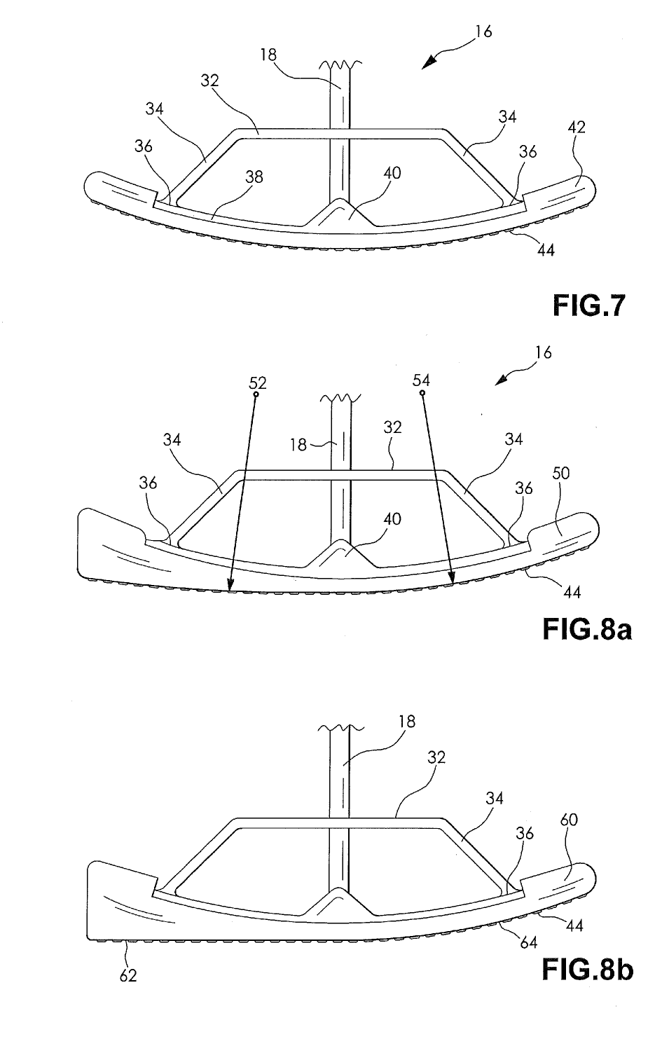

As illustrated in FIG. 7, the feet 38 can include a grip member 42 attached to a ground engaging lower surface thereof. The grip member 42 is formed from a rubber or an elastomeric material to facilitate maintaining a desired traction between the foot member 16 and the support surface, and cushion an impact between the feet 38 and the support surface. As shown, the grip member 42 includes a plurality of protuberances or an array of elements 44 extending outwardly from a bottom surface of the feet 38. The protuberances 44 are adapted to enhance the gripping and/or cushioning properties of the grip member 42. It should be understood that the bottom surface of the grip member 42 can be substantially smooth. Further, it should be understood that a linear or otherwise shaped foot can be formed to receive the grip member 42, wherein the grip member 42 is formed to provide the desired arcuate-shape to the ground engaging lower surface of the foot member 16.

The arcuate-shaped feet 38 illustrated in FIGS. 1-6 and the grip member 42 illustrated in FIG. 7 are generally defined by a single radius. However, the arcuate-shaped feet 38 and the grip member 42 can have a shape defined by more than one radius, and can include linear portions. An arcuate-shaped foot 50 according to another embodiment of the invention is illustrated in FIG. 8a. The generally arcuate-shaped foot 50 includes a first radius 52 at a leading end or toe of the foot 50 and a second radius 54 extending therefrom to form a trailing end or heel of the foot 50. In the embodiment shown, the first radius 52 is greater than the second radius 54. Favorable results have been obtained employing a radius of about twenty-six inches for the first radius 52 and about a thirteen inch radius for the second radius 54. A transition from the first radius 52 to the second radius 54 may occur substantially at a mid-point along the length of the feet 38. However, it should be understood that other dimensions can be used for the radii 52, 54, and the transition between the radii 52, 54 can be located at a other points along the length of the feet 38.

A generally arcuate-shaped foot 60 according to another embodiment of the invention is illustrated in FIG. 8b. The foot 60 includes a linear portion 62 at a leading end or a toe of the foot 60 and an arcuate portion 64 extending from the linear portion 62 to form a trailing end or heel of the foot 60. Favorable results have been obtained employing about a thirteen inch radius to define the arcuate portion 64. A transition from the linear portion 62 to the arcuate portion 64 may occur substantially at a mid-point along the length of the feet 38. However, it should be understood that other dimensions can be used for the arcuate portion 64, and the transition between the linear portion 62 and the arcuate portion 64 can be located at other points along the length of the feet 38. Additionally, it should be understood that other composite shapes can be employed for the feet 38 that include arrangements and quantities of arcuate and linear portions different from the illustrated embodiments.

The mobility assistance device 10 having the composite shaped foot with a defined leading and trailing end is adapted to provide support to one of a left hand side or a right hand side of the user. With the leading end or toe of the feet 38 pointing away from the user, the main shaft 12 is offset to the left of the centerline between and parallel to the feet 38, and leans to the left side of the mobility assistance device 10 to facilitate supporting the right side of the user. Alternatively, when the main shaft 12 is offset toward and leans to the right side of the mobility assistance device 10, the mobility assistance device 10 facilitates supporting the left side of the user.

Alternatively, as described above, the grip members 42 can be attach to the feet 38 and provide the arcuate-shape or the composite shape for the ground engaging surfaces of the foot member 16. The grip members 42 can be adapted to be removable from the feet 38 and re-attached thereto in a reversed orientation in respect of the feet 38 to facilitate adapting the mobility assistance device 10 to support either the left side or the right side of the user.

It should be understood that the foot member 16 can be manufactured and sold as a separate component. In such a configuration, the foot member 16 is adapted to attach to a conventional mobility assistance device, such as a straight cane, for example. The foot member 16 can be attached to the conventional mobility assistance device in any manner, such as by a telescoping engagement or a threaded engagement, for example. Further, the means of attachment provided with the component foot member 16 can be adapted to position the conventional mobility assistance device in the offset and tilted configuration substantially similar to the mobility device 10.

Additionally, it should be understood that the main shaft 12 and the handle 14 can be manufactured and sold together or separately, wherein the main shaft 12 and/or the handle 14 are adapted to attach to a foot member of a conventional mobility assistance device. The main shaft 12 and/or the handle 14 being adapted to position the foot member of the conventional mobility assistance device in an offset position in respect of the handle 14, substantially similar to the mobility assistance device 10.

In use, the main shaft 12 is extended to a desired length by manipulating the engagement between the elongate member 18 and the elongate member 20. The handle portion 14 is oriented wherein the grip portion 28 points toward the user. The user grasps the grip 30 with a hand to securely hold the mobility assistance device 10. The user can exert a force on the handle 14 to support at least a portion of the user's weight, which is transferred through the main shaft 12 and the foot member 16 to the support surface, such as a floor or the ground.

The main shaft 12, being offset and tilted toward the user, positions the foot member 16 in a position that is laterally spaced further from the side of the user than the grip portion 28 of the handle 14. Thus, an interference between the foot member 16 and a normal movement of the leg and the foot of the user adjacent the mobility assistance device 10 is minimized. Additionally, the offset and tilt of the main shaft in respect of the foot member 16 allows a substantially direct vertical alignment between a shoulder of the user and the handle 14, to facilitate an ergonomic use of the mobility assistance device 10.

As the user moves forward or backward, the feet 38 pivot on the ground in a rocking motion to maximize a contact surface between the feet 38 and the ground throughout the entire forward or backward step. Since the foot member 16 includes at least a pair of spaced apart feet 38, or a single foot having a width substantially equivalent to the distance between the outer edges of the spaced apart feet 38, the stability of the mobility assistance device 10 is maximized in a side to side direction as well as in a front to back direction. Additionally, for the embodiment where the feet 38 include the grip member 42, a traction and an impact absorbing characteristic of the mobility assistance device 10 are maximized. Additionally, the grip member 42 can be replaced if it becomes damaged or worn, to maintain a desired level of the traction and the impact absorbing characteristics of the mobility assistance device 10.

The mobility assistance device 10 described herein provides a maximization of a traction between the foot member 16 and the ground, and provides a lateral stability to a user. Additionally, the unique structure of the main shaft 12, handle 14, and foot member 16 create an ergonomic mobility assistance device 10 that facilitates a proper posture of the user, which further enhances the stability of the user and minimizes a fatigue of the user.

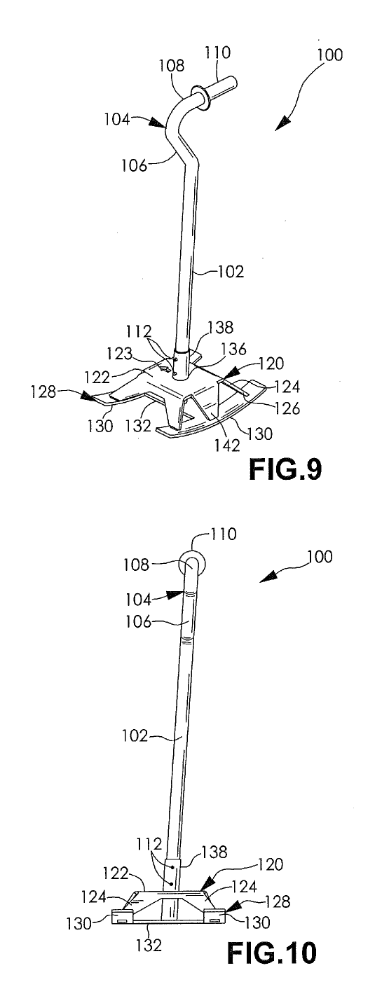

FIGS. 9-15 illustrate a mobility assistance device 100 in accordance with another embodiment of the invention. The mobility assistance device 100 includes a shaft 102 having a handle 104 formed at one end and a ground engaging member 120 disposed at an opposite end thereof. The shaft 102 may be formed from an elongate hollow tube such as a tube having one of a circle, a square, a rectangle, an oval, or other cross-sectional shape, for example. In the embodiment shown, the shaft 102 and the ground engaging member 120 are formed from a lightweight material such as aluminum, for example. However, other materials can be used to form the shaft 102 and the ground engaging member 120. In the illustrated embodiment, the shaft 102 is a fixed length shaft, it should be understood that the shaft 102 can be an adjustable length shaft, such as a two piece telescopic shaft, for example.

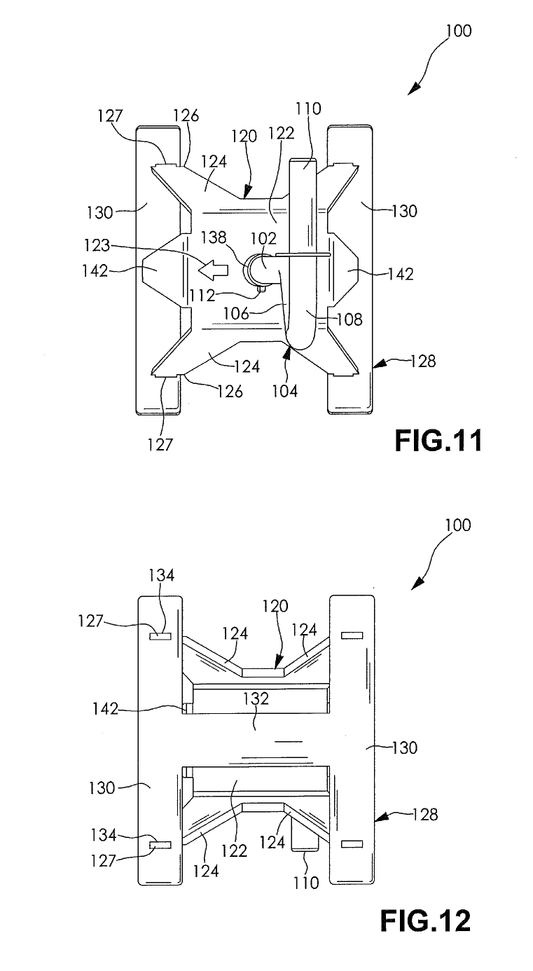

The handle 104 has a generally inverted L-shape with a leg portion 106 and a grip portion 108. It should be understood that other shapes can be employed for the handle 104 such as a U-shape, for example. It should be understood that the handle 104 can be removably and/or adjustably attached to an upper end of the shaft 102. The leg portion 106 is disposed at a forward leaning angle in respect of the shaft 102 to position the grip portion 108 substantially above the longitudinal axis of the shaft 102, as shown in FIG. 11. It should be understood that the leg portion 106 can be in longitudinal alignment with the shaft 102 or at angles other than the illustrated angle. A grip 110 is disposed on the grip portion 108 to facilitate a user securely grasping the grip portion 110. The grip 110 can be formed from a resilient material such as a foam rubber or an elastomeric material, for example. It should be understood that other materials can be employed to form the grip 110. A pair of retractable protuberances 112 is provided adjacent the end of the shaft 102 opposite the handle 104. Such retractable protuberances are disclosed in U.S. Pat. No. 5,301,704. The retractable protuberances 112 facilitate attaching the shaft 102 to the ground engaging member 120.

The ground engaging member 120 includes a support member 122 and a plurality of legs 124 depending therefrom. In the illustrated embodiment, the support member is a substantially flat plate. An indicium 123 is formed in the support member 122 adjacent a side of the mobility assistance device 100 intended to be the side farthest from the user thereof. In the illustrated embodiment, the indicium 123 is an arrow formed in the support member 122 pointing to the side of the mobility assistance device 100 intended to be the side farthest from the user thereof. However, other indicium 123 may be formed in or disposed on the support member 122, as desired. It should be understood that the support member can have other shapes such as a curved shape, a generally domed shape, and any other suitable shape, for example. In the illustrated embodiment, four of the legs 124 are provided, one adjacent a corner of the support member 122. The legs 124 are integrally formed with the support member 122 and extend downwardly therefrom to terminate at an end 126. As clearly shown in FIG. 14, a tab 127 is formed on and depends from the end 126 of each of the legs 124. It should be understood that the legs 122 can be formed as a separate component and attached to the support member 122 with a weld or a fastener, for example.

The legs 124 terminate adjacent a generally H-shaped foot 128 having a pair of spaced apart, arcuate-shaped, ground engaging rocker members 130 and a ground engaging cross-member 132 extending therebetween. The ground engaging cross-member 132 is arcuate in cross-section and provides additional contact area between the ground engaging member 120 and the support surface as compared to the ground engaging member 16 illustrated in FIGS. 1-8b, wherein the cross-member 40 does not engage the support surface. Openings 134 are formed in the ground engaging rocker members 130 to receive the tabs 127 of the legs 124. In the illustrated embodiment, the foot 128 is formed from a single piece of material employing a fabrication process such as at least one of a stamping and a cutting operation, for example. By forming the foot 128 from a single piece of material, a manufacturing cost of the ground engaging member 120 is minimized by eliminating the need to couple the ground engaging rocker members 130 to the cross-member 132 employing a separate manufacturing step such as a welding step, for example. Further, the tabs 127 and the openings 134 cooperate to minimize a manufacturing cost of the ground engaging member 120 by facilitating the assembly of the support member 122 to the foot 128. The tabs 127 are received in the openings 134 to place the support member 122 in a desired position in respect of the foot 128 while the support member 122 is substantially secured to the foot 128. It should be understood that the support member 122 can be substantially secured to the foot 128 employing a weld, an adhesive, a fastener, and the like, for example.

Favorable results have been obtained by providing a radius of thirteen inches for the arcuate H-shaped foot 128. However, it should be understood that the arcuate-shape can have a different radius, a plurality of radii, and include linear portions. Further favorable results have been obtained by spacing apart the ground engaging rocker members 130 by about four and one half inches, wherein each of the ground engaging rocker members 130 is about one inch wide and about ten and one half inches long. It should be understood that the ground engaging rocker members 130 can be spaced apart at other distances and have other widths and lengths as desired.

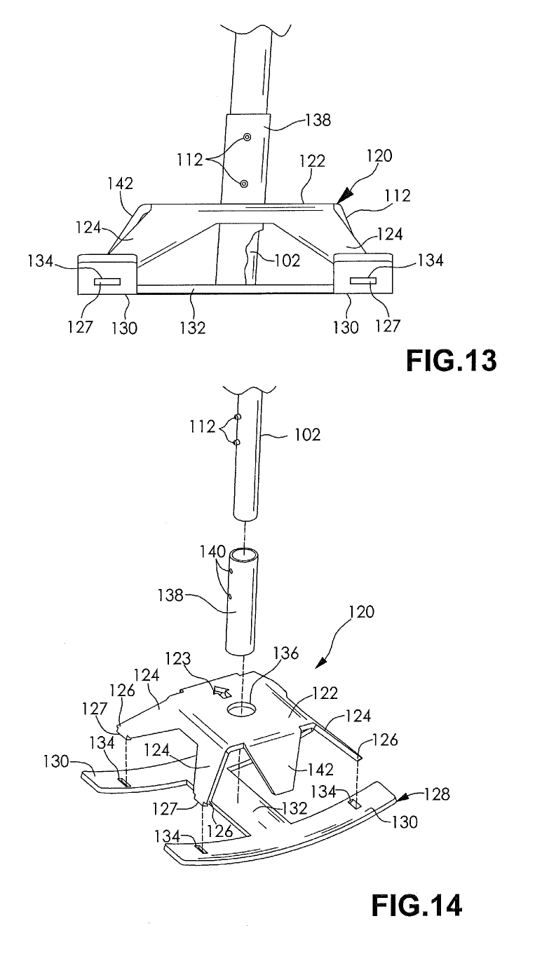

An aperture 136 is formed in the support member 122 to receive an elongate hollow member 138. One end of the elongate hollow member 138 is secured to the cross-member 132 of the foot 128. The elongate hollow member 138 extends from the cross-member 132 through the aperture 136 formed in the support member 122 and terminates at a distal end a selected distance from the support member 122. The elongate hollow member 138 is also secured to the support member 122 adjacent the opening 136 formed therein. The elongate hollow member 138 is secured to the support member 122 and the cross-member 132 by welding. However, it should be understood that the elongate hollow member 138 can be secured to the support member 122 and the cross-member 132 employing other means such as a fastener and an adhesive, for example. A first pair of axially aligned openings 140 is formed in the elongate hollow member 138. A second pair of axially aligned openings (not shown) is formed in the elongate hollow member 138 on a side opposite the openings 140. The openings 140 are formed adjacent the end opposite the cross-member 132. The shaft 102 is received within the elongate hollow member 138, wherein the end of the shaft 102 is caused to abut the cross-member 132, as clearly shown in FIG. 13. Weight applied to the handle 104 of the shaft 102 by the user is applied substantially directly to the cross-member 132 of the foot 128. The retractable protuberances 112 of the shaft 102 are placed in alignment with one of the pairs of openings 140 formed in the elongate hollow member 138. The retractable protuberances 112 of the shaft 102 are received by one of the first pair of openings 140 and the second pair of openings formed in the elongate hollow member 138 to couple the shaft 102 to the elongate hollow member 138. The retractable protuberances 112 and the first pair of openings 140 and the second pair of openings are oriented to position the grip portion 108 of the handle 104 in substantial longitudinal alignment with the ground engaging rocker members 130 when the retractable protuberances 112 are received by either of the first pair of openings 140 and the second pair of openings.

The elongate hollow member 138 is attached to the foot 128 offset from a centerline running between and parallel to a longitudinal axis of the ground engaging rocker members 130. The offset positions the shaft 102 closer to one of the ground engaging rocker members 130 and a side of the mobility assistance device 100 nearer the user thereof. Additionally, the elongate hollow member 138 is attached to the foot 128 at an angle. Thus, the elongate hollow member 138 leans toward the side of the mobility assistance device 100 nearer the user thereof. Accordingly, the shaft 102 is not orthogonal to the support surface, but is disposed at an angle, thereby tilting the shaft 102 toward the user. Favorable results have been obtained employing a five degree tilt angle from vertical for the elongate hollow member 138 and the shaft 102. The offset and angled position of the shaft 102 cooperates to place the grip portion 110 of the handle 104 in a position facilitating an optimized posture and walking gait of the user. It should be understood that other shaft offsets and tilt angles can be employed as desired to accommodate a particular physical makeup or a physical requirement of the user.

Shields 142 depend from the lateral sides of the support member 122 and terminate adjacent the ground engaging rocker members 130. It should be understood that the shields 142 may abut and be joined to the ground engaging rocker members 130. The side shields 128 are disposed between two adjacent legs 124 to cover at least a portion of the area therebetween. It should be understood that the shields 142 can cover the entire area between two adjacent legs 124 and can be integrally formed therewith. It should also be understood that one or more tabs (not shown) can be formed at the edge of the shields 42, wherein corresponding openings (not shown) are formed in the ground engaging rocker members 130 to receive the tabs of the shields 42. The shields 142 can be substantially secured to the ground engaging rocker members 130 employing a weld, an adhesive, a fastener, and the like, for example. The shields 142 militate against a foot of the user from being received between the legs 124 which can cause the user to loose balance. Further, the shields 142 militate against other objects from being received between the legs 124 which can cause the user to loose balance.

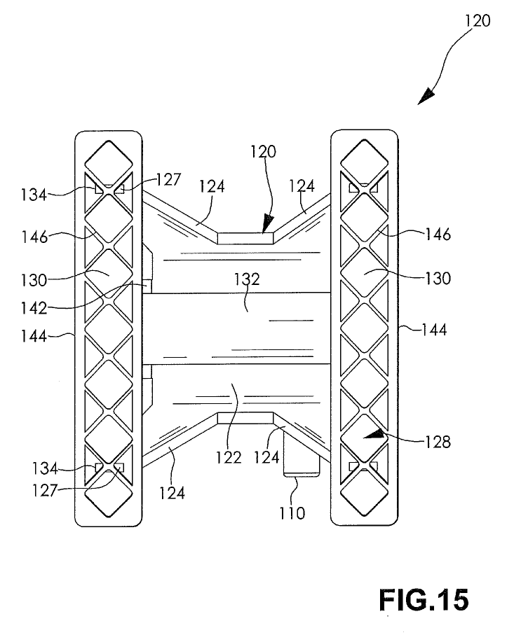

As illustrated in FIG. 15, the foot 128 can include a grip member 144 attached thereto. The grip member 144 may be formed from a rubber or an elastomeric material to facilitate maintaining a desired traction between the ground engaging member 120 and the support surface, and cushion an impact between the ground engaging member 120 and the support surface. In the illustrated embodiment, the grip member 144 is attached to each of the ground engaging rocker members 130. It should be understood that the grip member 144 can be formed to be a generally H-shaped grip member to substantially match the shape of the foot 128, wherein the grip is attached to the ground engaging rocker members 130 and the cross-member 134. The grip member 144 includes a plurality of apertures 146 formed therein. The apertures 146 minimize a weight of the grip member 142 while providing the desired traction and cushioning properties. It should be understood that the grip member 144 can include a plurality of protuberances (not shown) substantially similar to the protuberances 44 shown in FIGS. 7-8b.

The mobility assistance device 100 illustrated in FIGS. 9-15 is adapted to be employed for supporting a right hand side of the user. However, it should be understood that the shaft 102 can be rotated 180 degrees in respect of the ground engaging member 120, to adapt the mobility assistance device 100 for use on a left hand side of the user.

The foot 128 is generally defined by a single radius. However, the arcuate-shaped foot 128 can have a shape defined by more than one radius, and can include linear portions, substantially similar to the feet 50, 60 shown in FIGS. 8a-8b and described herein above.

In use, the shaft 102 is oriented in respect of the ground engaging member 120 to cause the shaft 102 to tilt toward the user. Accordingly, the shaft 102 can be rotated 180 degrees in respect of the ground engaging member 120 to accommodate use of the mobility device 100 on the right side or the left side of the user. The user grasps the grip 110 with a hand to securely hold the mobility assistance device 100. The user can exert a force on the handle 104 to support at least a portion of the user's weight, which is transferred through the shaft 102 and the foot 128 to the support surface, such as a floor or the ground.

The shaft 102, being offset and tilted toward the user, positions the ground engaging member 120 in a position that is laterally spaced farther from the side of the user than the grip portion 108 of the handle 104. Thus, an interference between the ground engaging member 120 and a normal movement of the leg and the foot of the user adjacent the mobility assistance device 100 is minimized. Additionally, the offset and tilt of the shaft 102 in respect of the ground engaging member 120 allows a substantially direct vertical alignment between a shoulder of the user and the handle 104, to facilitate an ergonomic use of the mobility assistance device 100.

As the user moves forward or backward, the foot 128 pivots on the support surface in a rocking motion to maximize a contact surface between the foot 120 and the support surface throughout the entire forward or backward step. The spaced apart rocker members 130 of the ground engaging member 120 maximize a stability of the mobility assistance device 100 in a side to side direction as well as in a front to back direction. Additionally, for the embodiment shown in FIG. 15 where the foot 128 includes the grip member 144, a traction and an impact absorbing characteristic of the mobility assistance device 100 are maximized. Further, the grip member 144 can be replaced if it becomes damaged or worn, to maintain a desired level of the traction and the impact absorbing characteristics of the mobility assistance device 100. The shields 142 militate against a foot of the user or other objects from being caught between the support member 122, the legs 124, and the ground engaging rocker members 130 which could cause the user to loose balance.

The mobility assistance device 100 described herein provides a maximization of a traction between the foot 128 of the ground engaging member 120 and the support surface, and provides a lateral stability to a user. Additionally, the unique structure of the shaft 102, handle 104, and the ground engaging member 120 create an ergonomic mobility assistance device 100 that facilitates a proper posture of the user, which further enhances the stability of the user and minimizes a fatigue of the user.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A ground engaging member for a mobility assistance device comprising:
a support member including an aperture formed therein;
a generally arcuate foot depending from the support member for contacting a support surface, the generally arcuate foot including a pair of spaced apart ground engaging rocker members and a ground engaging cross-member interposed between the ground engaging rocker members; and
an elongate hollow member having one end coupled to the ground engaging cross-member and extending through the aperture formed in the support member to removably receive an end of a shaft.

2. The ground engaging member according to claim 1, further comprising a plurality of legs integrally formed with the support member and depending therefrom, the legs joined to the ground engaging rocker members.

3. The ground engaging member according to claim 2, including a tab formed on an end of each of the legs and a plurality of openings formed in the ground engaging rocker members, wherein the tabs formed on the end of the legs are received in the openings formed in the ground engaging rocker members to facilitate joining the legs thereto.

4. The ground engaging member according to claim 1, further comprising at least one shield depending from the support member and terminating adjacent one of the ground engaging rocker members to cover at least a portion of an opening between the support member and the one of the ground engaging rocker members.

5. The ground engaging member according to claim 1, wherein the generally arcuate foot forms a single radius.

6. The ground engaging member according to claim 5, wherein the radius is about thirteen inches.

7. The ground engaging member according to claim 1, wherein the generally arcuate foot forms a plurality of radii.

8. The ground engaging member according to claim 1, wherein the generally arcuate foot forms at least one radius and at least one linear portion.

9. The ground engaging member according to claim 1, further comprising a grip member disposed on the generally arcuate foot, the grip member including a plurality of apertures formed therein.

10. The ground engaging member according to claim 1, wherein the elongate hollow member is coupled to the ground engaging cross-member of the foot at a position offset toward one of the ground engaging rocker members.

11. The ground engaging member according to claim 1, wherein the elongate hollow member is coupled to the ground engaging cross-member of the foot at an angle in respect of vertical to cause the elongate hollow member to lean toward one of the ground engaging rocker members.

12. A mobility assistance device comprising:
a support member including an aperture formed therein;
a generally arcuate foot depending from the support member for contacting a support surface, the generally arcuate foot including a pair of spaced apart ground engaging rocker members and a ground engaging cross-member interposed between the ground engaging rocker members;
an elongate hollow member having one end coupled to the ground engaging cross-member and extending through the aperture formed in the support member; and
a shaft having a first end and a second end, the first end including a handle and the second end removably received within the elongate hollow member, wherein the elongate hollow member is at an angle in respect of vertical to cause the shaft to lean toward one of the ground engaging rocker members.

13. The mobility assistance device according to claim 12, wherein the second end of the shaft abuts the ground engaging cross-member.

14. The mobility assistance device according to claim 12, further comprising at least one shield depending from the support member and terminating adjacent one of the ground engaging rocker members to cover at least a portion of an opening between the support member and the one of the ground engaging rocker members.

15. The mobility assistance device according to claim 12, wherein the elongate hollow member is coupled to the ground engaging cross-member of the foot at a position offset toward one of the ground engaging rocker members.

16. The mobility assistance device according to claim 12, wherein the angle of the elongate hollow member is about five degrees.

17. The mobility assistance device according to claim 12, further comprising a grip member disposed on the generally arcuate foot, the grip member including a plurality of apertures formed therein.

18. A mobility assistance device comprising:
a support member including an aperture formed therein;
a generally arcuate foot depending from the support member for contacting a support surface, the generally arcuate foot including a pair of spaced apart ground engaging rocker members and a ground engaging cross-member interposed between the ground engaging rocker members; and
an elongate hollow member having one end coupled to the ground engaging cross-member and extending through the aperture formed in the support member;
a shaft having a first end and a second end, the first end including a handle and the second end removably received within the elongate hollow member and abutting the ground engaging cross-member, wherein the elongate hollow member is attached to the ground engaging cross-member member at a position offset toward one of the ground engaging rocker members, and the elongate hollow member is at about a five degree angle in respect of vertical to cause the shaft to lean toward one of the ground engaging rocker members.

19. The mobility assistance device according to claim 18, further comprising at least one shield depending from the support member and terminating adjacent one of the ground engaging rocker members to cover at least a portion of an opening between the support member and the one of the ground engaging rocker members.

20. The mobility assistance device according to claim 18, further comprising:
a plurality of legs integrally formed with the support member and depending therefrom, each of the legs including a tab formed on an end thereof; and
a plurality of openings formed in the ground engaging rocker members, wherein the tabs formed on the end of the legs are received in the openings formed in the ground engaging rocker members to facilitate joining the legs thereto.
